(19) United States
(12) Patent Application Publication
(10) Pub. No.: US 2025/0282343 A1
(43) Pub. Date: Sep. 11, 2025

(54) VEHICLE CONTROL METHOD AND VEHICLE CONTROL DEVICE

(71) Applicant: Panasonic Automotive Systems Co., Ltd., Kanagawa (JP)

(72) Inventors: Akihito MURAI, Kanagawa Ken (JP); Hirofumi NISHIMURA, Kanagawa Ken (JP)

(73) Assignee: Panasonic Automotive Systems Co., Ltd., Kanagawa (JP)

(21) Appl. No.: 19/045,183

(22) Filed: Feb. 4, 2025

(30) Foreign Application Priority Data
Mar. 11, 2024 (JP) 2024-036616

(51) Int. Cl. B60W 30/06; B60W 30/09; G01C 21/36; G01S 13/931; G01S 15/931; G01S 17/931

(52) U.S. Cl. CPC B60W 30/06; B60W 30/09; G01C 21/3626; G01S 13/931; G01S 15/931; G01S 17/931; G01S 2013/9314; G01S 2015/932

(57) ABSTRACT

A vehicle control method executed in a vehicle that includes a sensor that acquires an external situation and capable of detecting an obstacle, a display visually recognizable by an occupant, and a movement controller that controls at least steering, the vehicle being capable of autonomously traveling to a parking target position along a teacher route obtained by teacher traveling from a predetermined position to the parking target position, by controlling at least steering. The vehicle control method includes: storing a travel route actually traveled and an external situation acquired through a sensor at a time of a teacher traveling; correcting the stored travel route based on the stored external situation; displaying, through the display, a correction route obtained by correcting the travel route; and storing the correction route as the teacher route.

### CROSS-REFERENCE TO RELATED APPLICATIONS

This application is based upon and claims the benefit of priority from Japanese Patent Application No. 2024-036616, filed on Mar. 11, 2024, the entire contents of which are incorporated herein by reference.

### FIELD

The present disclosure relates to a vehicle control method and a vehicle control device.

### BACKGROUND

In general, there are many narrow parking spaces at a house, and it may be difficult to park the vehicle. Therefore, there is a high need to perform parking and getting a vehicle out of the shed by automatic driving.

A vehicle control device that realizes this type of automatic driving is known. For example, a technique is disclosed in which a vehicle is caused to travel from a predetermined position outside a parking area to a parking target position by a driving operation by a driver, a travel route at the time is stored in advance as a teacher route, and the vehicle is caused to autonomously travel along the teacher route in a parking scene after that (see JP 2019-147480 A).

Related technique are described in JP 2018-124920 A, WO 2019/058781 A, and JP 2022-069161 A.

However, in the related art technique, there is a case where a route that is difficult to follow at the time of autonomous traveling is stored as a teacher route, and there is a case where parking assistance by autonomous traveling is difficult. That is, in the prior art, it may be difficult to provide suitable parking assistance.

The present disclosure has an object to provide a vehicle control method and a vehicle control device that can provide more suitable parking assistance.

### SUMMARY

A vehicle control method according to the present disclosure is executed in a vehicle. The vehicle includes a sensor, a display, and a movement controller. The sensor acquires an external situation. The display is visually recognizable by an occupant. The movement controller controls at least steering. The vehicle is capable of autonomously traveling to a parking target position along a teacher route by controlling at least steering. The teacher route is obtained by teacher traveling from a predetermined position to the parking target position. The sensor is capable of detecting an obstacle at least in a first side direction with respect to the vehicle and in a second side direction opposite to the first side direction. The vehicle control method includes: storing a travel route actually traveled and an external situation acquired through the sensor at a time of the teacher traveling; correcting the stored travel route based on the stored external situation; displaying, through the display, a correction route obtained by correcting the travel route; and storing the correction route as the teacher route.

### BRIEF DESCRIPTION OF THE DRAWINGS

FIG. 1 is a block diagram illustrating an example of an overall configuration of a vehicle;

FIG. 2 is a schematic diagram illustrating an example of arrangement of sensors;

FIG. 3 is an explanatory diagram of an example of a teacher route;

FIG. 4 is a diagram illustrating an example of a data configuration of a route management DB;

FIG. 5 is an explanatory diagram of an example of generation of a correction route;

FIG. 6 is an explanatory diagram of an example of generation of a correction route;

FIG. 7 is a schematic diagram of an example of a display screen;

FIG. 8 is a flowchart illustrating an example of a flow of information processing executed by a control unit in a teacher traveling mode;

FIG. 9 is a flowchart illustrating an example of a flow of a teacher route storage process executed by a control unit;

FIG. 10 is a flowchart illustrating an example of a flow of information processing executed by a control unit in an autonomous traveling mode; and

FIG. 11 is a block diagram illustrating a hardware configuration example of a vehicle control device.

### DETAILED DESCRIPTION

Hereinafter, embodiments of a vehicle control method and a vehicle control device according to the present disclosure will be described with reference to the drawings.

### Overall Configuration of Vehicle

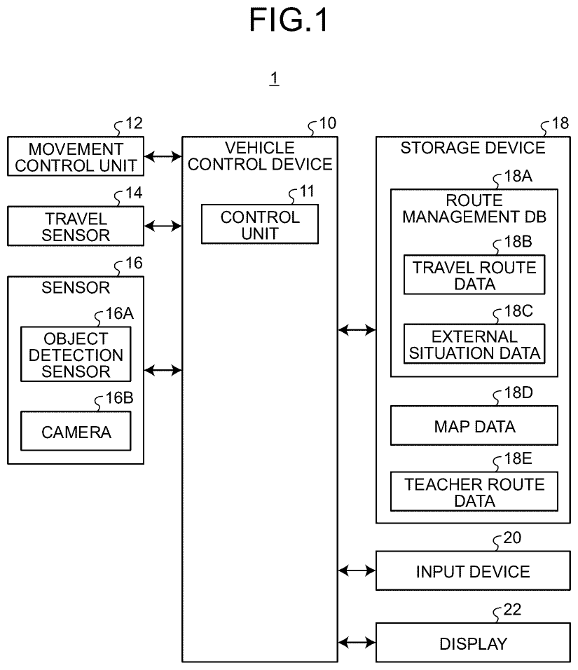

FIG. 1 is a block diagram illustrating an example of an overall configuration of a vehicle 1.

The vehicle 1 includes a vehicle control device 10, a movement control unit (movement controller) 12, a travel sensor 14, a sensor 16, a storage device 18, an input device 20, and a display 22.

The movement control unit 12, the travel sensor 14, the sensor 16, the storage device 18, the input device 20, and the display 22 are connected to the vehicle control device 10 so as to be able to exchange data or signals. That is, the vehicle control device 10 is set to be communicably connected to at least the sensor 16, the display 22, and the movement control unit 12.

The movement control unit 12 controls at least steering of the vehicle 1. The movement control unit 12 is a means that realizes driving, braking, and turning motions necessary for traveling of the vehicle 1. For example, the movement control unit 12 includes a drive motor, a power transmission mechanism, a brake device, a steering device, and the like, and an electronic vehicle control device that controls the drive motor, the power transmission mechanism, the brake device, the steering device, and the like. The movement control unit 12 causes the vehicle 1 to travel by, for example, generating power with a drive motor and transmitting the power to wheels via a power transmission mechanism. The power transmission mechanism is, for example, a propeller shaft, a differential gear, a drive shaft, or the like. Controlling at least steering means that the movement control unit 12 controls at least one of driving, braking, and turning motions necessary for traveling of the vehicle 1. That is, controlling steering means that the movement control unit 12 controls at least one of a turning direction by steering, a vehicle speed and acceleration by accelerator steering, and deceleration and stop by brake steering.

The travel sensor 14 is various sensors that are mounted on the vehicle 1 and detect a travel state of the vehicle 1. The travel sensor 14 includes, for example, an accelerator opening sensor that detects an accelerator opening, a steering angle sensor that detects a steering angle of a steering device, an acceleration sensor that detects acceleration acting in the front-rear direction of the vehicle 1, a torque sensor that detects torque acting on a power transmission mechanism between wheels of the vehicle 1 and a drive motor, a vehicle speed sensor that detects a vehicle speed of the vehicle 1, a wheel speed sensor, and the like. The travel sensor 14 outputs travel sensor information obtained by the detection to the vehicle control device 10.

The sensor 16 is a sensor that acquires a situation outside the vehicle 1. The sensor 16 includes an object detection sensor 16A and a camera 16B. The object detection sensor 16A is a sensor that detects the presence or absence of an object, the distance to the object, and the like. The object detection sensor 16A includes, for example, a sonar that transmits and receives a sound wave, a radar or a light detection and ranging (LiDAR) that transmits and receives an electromagnetic wave, and the like.

The camera 16B is a surrounding sensor that is mounted on the vehicle 1 and monitors the surrounding environment of the vehicle 1. The camera 16B includes an imaging element and obtains captured video data obtained by capturing the surroundings of the vehicle 1. Hereinafter, the captured video data may be simply referred to as a captured video. In the present embodiment, the camera 16B is also applied to an application of detecting an object present around the vehicle 1 and estimating the position of the vehicle 1 from the positional relationship between the vehicle 1 and the object present around the vehicle 1, and an application of detecting an object around the vehicle 1.

Note that the sensor 16 may be any sensor that acquires a situation outside the vehicle 1. That is, the sensor 16 may be configured to include at least one of a camera including an imaging element, a sonar that transmits and receives a sound wave, and a radar or a lidar that transmits and receives an electromagnetic wave.

The sensor 16 sequentially outputs the external situation data including the detection result acquired by the object detection sensor 16A and the captured video acquired by the camera 16B to the vehicle control device 10. The external situation data is data representing a situation outside the vehicle 1, and is data including a detection result by the object detection sensor 16A and a video captured by the camera 16B.

The position, the number of installations, and the detection direction of the sensor 16 are adjusted in advance so that the surrounding situation of the vehicle 1 can be acquired.

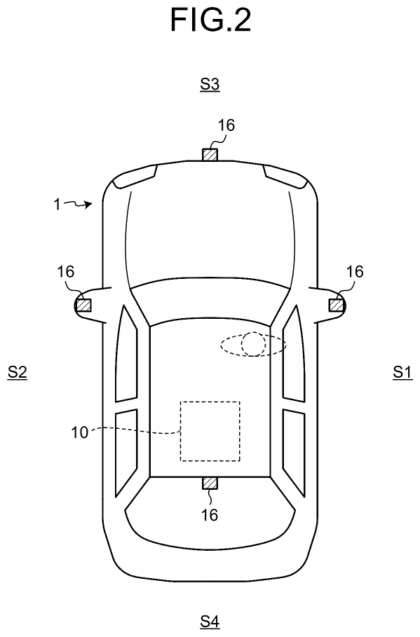

FIG. 2 is a schematic diagram illustrating an example of arrangement of the sensor 16.

The vehicle 1 is provided with, for example, four sensors 16 so as to be able to acquire a situation outside the vehicle 1 in at least four directions of the first side direction S1, the second side direction S2, the front side direction S3, and the rear side direction S4 of the vehicle 1. The first side direction S1 is one of side directions with respect to the vehicle 1. The second side direction S2 is a side direction opposite to the first side direction S1 with respect to the vehicle 1. Note that the number of sensors 16 provided in the vehicle 1 is not limited to four.

Therefore, the sensor 16 can detect at least obstacles in the first side direction S1 and the second side direction S2 with respect to the vehicle 1. The sensor 16 can also detect obstacles in the front side direction S3 and the rear side direction S4 with respect to the vehicle 1.

The obstacle is an object that is difficult to continue traveling when the vehicle 1 comes into contact with the object, or an object that may cause some damage to the vehicle 1 or an event that hinders traveling when the vehicle 1 comes into contact with the object or tries to pass over the object without avoiding the object.

The storage device 18 stores various pieces of data. In the present embodiment, the storage device 18 stores data such as a route management database (DB) 18A, map data 18D, and teacher route data 18E. The route management DB 18A includes travel route data 18B and external situation data 18C. Details of the route management DB 18A, the travel route data 18B, the external situation data 18C, the map data 18D, and the teacher route data 18E will be described later. The storage device 18 is, for example, an auxiliary storage device such as a hard disk drive (HDD), a solid state drive (SSD), or a flash memory. Note that at least part of the data included in the storage device 18 may be stored in an external storage device such as a server device provided outside the vehicle 1 and communicably connected to the vehicle control device 10.

The input device 20 receives an operation by an occupant of the vehicle 1. The input device 20 includes a steering device such as a steering wheel (handle), an operation mechanism related to a driving operation such as an accelerator pedal, a brake pedal, a blinker lever, and a push-in switch, and an input device such as a keyboard, a touch panel, and a switch. The input device 20 may constitute part of a human machine interface (HMI).

The display 22 is a display that displays various images. The display 22 is installed at a position visually recognizable by an occupant who is an occupant of the vehicle 1. Examples of the display include a liquid crystal display (LCD), an organic electro-luminescence (EL) display, and a projector. The display may be a touch panel display in which the display 22 and the input device 20 are integrally configured. The display 22 is an example of the HMI.

The vehicle control device 10 is an electronic control unit that integrally controls each part of the vehicle 1.

The vehicle control device 10 controls the movement control unit 12 so as to optimize the travel state of the vehicle 1 using travel sensor information, external situation data, and the like received from the travel sensor 14 and the sensor 16. In addition, the vehicle control device 10 controls the movement control unit 12 to cause the vehicle 1 to autonomously travel.

The vehicle control device 10 includes a control unit 11. Part or all of the control unit 11 may have a software configuration realized by cooperation of a processor and various programs stored in a memory. In addition, part or all of the control unit 11 may have a hardware configuration realized by a dedicated circuit or the like.

The control unit 11 integrally controls each part of the vehicle 1.

In the present embodiment, the control unit 11 is configured to be able to switch the traveling mode to the teacher traveling mode or the autonomous traveling mode based on an input operation or the like on the input device 20 by the occupant. The traveling mode executable by the vehicle 1 may include various traveling modes other than the teacher traveling mode and the autonomous traveling mode.

The teacher traveling mode is a mode for registering a teacher route when the vehicle 1 autonomously travels. The teacher route is a route obtained by teacher traveling from a predetermined position to a parking target position. In the teacher traveling mode, the vehicle 1 is controlled to travel by the driving operation by the occupant. That is, in the teacher traveling mode, the control unit 11 controls the movement control unit 12 to travel according to the driving operation by the occupant.

The autonomous traveling mode is a mode in which the vehicle 1 autonomously travels. In the present embodiment, the autonomous traveling mode means a mode in which the vehicle 1 autonomously travels along the teacher route. In the autonomous traveling mode, the control unit 11 controls at least steering to control the movement control unit 12 to travel along the teacher route. In the autonomous traveling mode, the vehicle 1 is automatically controlled to travel by the vehicle control device 10 without through the driving operation by the occupant.

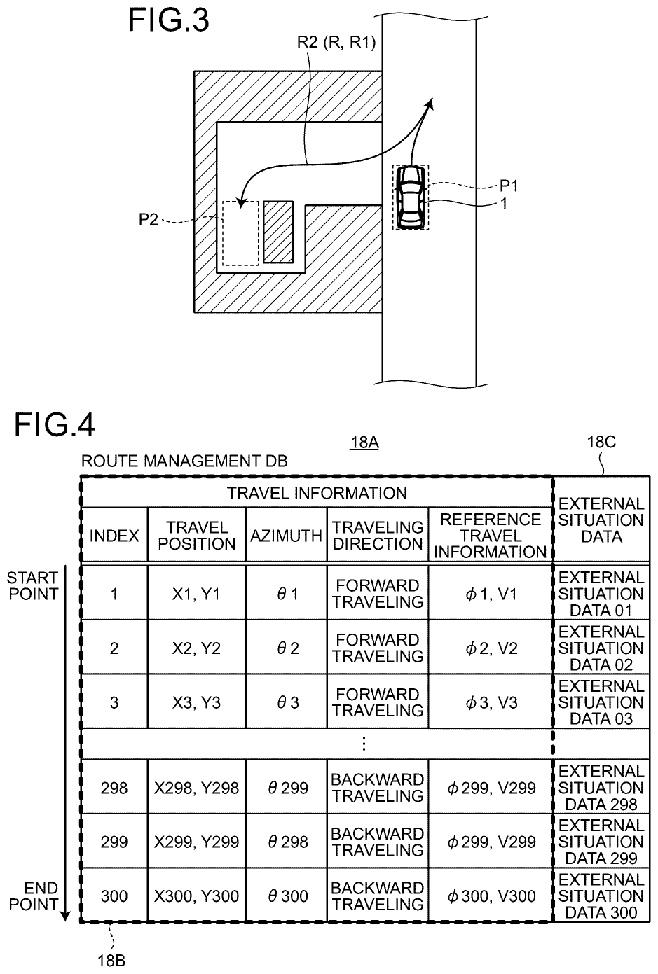

FIG. 3 is an explanatory diagram of an example of a teacher route R2.

In the teacher traveling mode, the teacher traveling from the predetermined position P1 to the parking target position P2 is performed by the driving operation by the occupant. The parking target position P2 is, for example, a parking lot or the like, but is not limited thereto. Further, the predetermined position P1 may be any position of the occupant in the real space.

The travel route R traveled by the teacher traveling is treated as the teacher route R2, and the teacher route data 18E of the teacher route R2 is stored in the storage device 18. At the time of teacher traveling, the occupant may perform driving operation so that the vehicle travels from the parking target position P2 toward the predetermined position P1, or may perform driving operation so that the vehicle travels from the predetermined position P1 toward the parking target position P2. When the vehicle 1 travels from the parking target position P2 toward the predetermined position P1 in the teacher traveling mode, the control unit 11 may create the teacher route data 18E of the teacher route R2 in which the traveling direction of the travel route R at the time of teacher traveling is set to the reverse direction. When the vehicle 1 travels from the predetermined position P1 toward the parking target position P2 at the time of teacher traveling, the control unit 11 may create the teacher route data 18E of the teacher route R2 along the traveling direction of the travel route R at the time of teacher traveling. Details of the creation of the teacher route data 18E will be described later.

In the autonomous traveling mode, the control unit 11 causes the vehicle 1 to autonomously travel to the parking target position P2 by controlling at least steering along the travel route R obtained by the teacher traveling. In the autonomous traveling mode, the control unit 11 executes steering control and front and rear acceleration/deceleration control of the vehicle 1, but at least part of front and rear acceleration/deceleration control may be executed by a driver's operation.

Next, control by the control unit 11 in each of the teacher traveling mode and the autonomous traveling mode will be described in detail.

### In Teacher Traveling Mode

First, the control of the control unit 11 in the teacher traveling mode will be described in detail.

When receiving a signal indicating an instruction to start the teacher traveling mode by the operation of the input device 20 by the occupant or the like, the control unit 11 switches the traveling mode to the teacher traveling mode. Then, the control unit 11 executes the following processing in the teacher traveling mode.

The control unit 11 acquires travel sensor information indicating the travel state of the vehicle 1 from the travel sensor 14. Then, the control unit 11 estimates the current position of the vehicle 1 based on a temporal change in the sensor value indicated by the travel sensor information. For example, the control unit 11 calculates a movement amount of the vehicle 1 from a reference position such as a traveling start position when the teacher traveling mode is started based on a temporal change in the vehicle speed and the yaw rate represented by the sensor values, and estimates the current position of the vehicle 1 based on the movement amount.

Note that the estimation accuracy of the current position based on the movement amount may be low. Therefore, the control unit 11 may use a result of correcting the estimated current position as the current position based on the captured image around the vehicle 1 acquired by the camera 16B.

The control unit 11 sequentially stores the current position of the vehicle 1 sequentially estimated along the travel of the vehicle 1 in the storage device 18. Specifically, the control unit 11 stores, in the storage device 18, the travel route data 18B representing the travel route R at the time of teacher traveling represented by the group of the current positions sequentially estimated from the time point when the instruction to start the teacher traveling mode is received to when the instruction to end the teacher traveling mode is received. In addition, the control unit 11 stores external situation data 18C representing the external situation acquired by the sensor 16 at the time of teacher traveling in the storage device 18. In the present embodiment, a mode in which the control unit 11 registers the travel route data 18B and the external situation data 18C in the route management DB 18A in association with each other will be described as an example.

FIG. 4 is a diagram illustrating an example of a data configuration of the route management DB 18A.

The route management DB 18A is a database in which the travel route data 18B and the external situation data 18C are associated with each other. The data format of the route management DB 18A is not limited to the database.

The travel route data 18B is data representing a travel route R that is a route on which the vehicle 1 actually traveled at the time of teacher traveling. The travel route data 18B includes a group of pieces of travel information for each position which is a current position sequentially estimated at the time of teacher traveling. The travel information includes an INDEX, a travel position, an azimuth, a traveling direction, and reference travel information. INDEX is identification information of travel information. The travel position is the estimated position of the vehicle 1. The azimuth indicates an orientation of the vehicle 1 at the position. The traveling direction indicates a traveling direction of the vehicle 1 at the position, and is represented by, for example, forward traveling or backward traveling. The reference travel information is information indicating a travel state or the like at the position. The reference travel information is, for example, information such as a steering angle and a vehicle speed detected at each position at the time of teacher traveling.

The control unit 11 registers the travel route data 18B including a group of travel information for each position sequentially estimated at the time of teacher traveling and the external situation data 18C acquired by the sensor 16 at each position in the route management DB 18A in association with each other. That is, in the route management DB 18A, the travel information for each position constituting the travel route data 18B and the external situation data 18C acquired by the sensor 16 at each position are registered in association with each other.

Returning to FIG. 1, the description will be continued.

In addition, at the time of teacher traveling of the vehicle 1, the control unit 11 creates the map data 18D for estimating the current position of the vehicle 1 from the captured video captured by the camera 16B. As a method of estimating the current position of the vehicle 1 from the captured video, a simultaneous localization and mapping (SLAM) method or the like is used.

The map data 18D is map data in which a plurality of feature points around the vehicle 1 at the time of traveling along the teacher route R2 is registered.

The feature point is a feature point obtained by performing image analysis on a captured image captured by the camera 16B at the time of teacher traveling. For example, the feature point is a portion where a characteristic image pattern can be obtained by analyzing the captured image of an object (for example, a tree, a wall, a column, or the like) or the like that can be a mark in the real view. The portion is, for example, an edge portion of the object. The map data 18D includes a plurality of feature points, and each feature point is identifiably registered for each feature point by being assigned an identification number.

The feature point is represented by feature point data including a three-dimensional position and a feature amount. The three-dimensional position of the feature point is a three-dimensional position of the feature point in the real space, and is represented by, for example, a three-dimensional orthogonal coordinate system (X, Y, Z). The feature amount of the feature point is a characteristic amount of the feature point represented by image analysis of the captured image. The feature amount of the feature point is, for example, luminance and density on the captured image, a scale invariant feature transform (SIFT) feature amount, a speeded up robust features (SURF) feature amount, or the like.

In the map data 18D, one feature point is registered for each identical three-dimensional position. Note that, for the same three-dimensional position, a plurality of feature points may be registered in the map data 18D for each capturing position and capturing direction by the camera 16B at the three-dimensional position. In addition, the feature point data of the feature points registered in the map data 18D may further include image data of an object having the feature point.

At the time of teacher traveling, the control unit 11 identifies coordinates of the feature point in the real view based on, for example, stereo photogrammetry. Specifically, the control unit 11 reads a plurality of captured images captured at different timings, and associates the same feature point commonly appearing in the plurality of captured images. Then, for example, the control unit 11 estimates the temporary position of the vehicle 1 when the plurality of captured images is captured, and identifies the temporary coordinates of the feature point in the real view by the principle of triangulation. Then, for example, the control unit 11 performs bundle adjustment using the temporary position of the vehicle 1 and the temporary coordinates of the feature point in the real view as reference information, and calculates the formal position of the vehicle 1 and the formal coordinates of the feature point in the real view so as to minimize a reprojection error when each feature point in the real view is projected on all the captured images. Then, the control unit 11 stores, in the storage device 18, the map data 18D in which the feature point represented by the feature point data including the formal coordinates of the feature point in the real view as the three-dimensional position is registered.

The three-dimensional position of the feature point registered in the map data 18D may be a position measured in advance using light detection and ranging (LiDAR) or a stereo camera without using the SLAM method. However, from the viewpoint of suppressing a decrease in position estimation accuracy, it is preferable to use the SLAM method.

As described above, the control unit 11 executes the above processing in the teacher traveling mode. Therefore, in the teacher traveling mode, the control unit 11 stores, in the storage device 18, the travel route data 18B of the travel route R obtained by the teacher traveling from the predetermined position P1 to the parking target position P2 and the external situation data 18C representing the external situation acquired by the sensor 16 at the time of teacher traveling. In the teacher traveling mode, the control unit 11 generates the map data 18D in which the three-dimensional position of each of the plurality of feature points around the vehicle 1 at the time of teacher traveling and the feature amount of the feature point are registered, and stores the map data in the storage device 18. Note that, as described above, the control unit 11 may store at least some data in an external storage device provided outside the vehicle 1.

### In Autonomous Traveling Mode

Next, the control of the control unit 11 in the autonomous traveling mode will be described in detail.

The control unit 11 switches the traveling mode to the autonomous traveling mode when receiving a signal indicating an instruction to start the autonomous traveling mode by the operation of the input device 20 by the occupant. Then, the control unit 11 executes the following processing in the autonomous traveling mode.

For example, a description will be given assuming a case where autonomous traveling is performed using the travel route R on which the vehicle actually traveled at the time of teacher traveling as the teacher route R2. In this case, the control unit 11 stores the travel route data 18B in the storage device 18 as the teacher route data 18E. Then, in the autonomous traveling mode, the control unit 11 reads the teacher route data 18E and the map data 18D from the storage device 18, and controls the movement control unit 12 to perform autonomous traveling along the teacher route R2 represented by the teacher route data 18E.

The control unit 11 estimates the current position of the vehicle 1 based on the map data 18D and the captured image around the vehicle 1 acquired by at least one camera 16B.

For example, the control unit 11 collates the characteristic point extracted from the captured image by the camera 16B with the feature point stored in the map data 18D using pattern matching, feature amount search, or the like. Then, the control unit 11 randomly selects several (for example, three to six) feature points among the characteristic points that are extracted from the captured image by the camera 16B and can be collated with the characteristic points stored in the map data 18D.

Then, the control unit 11 estimates the current position of the vehicle 1 in the real space based on the positions of these several characteristic points in the captured image and the three-dimensional positions of the feature points registered in the map data 18D corresponding to the several characteristic points in the real space. At this time, the control unit 11 estimates the current position of the vehicle 1 by solving the PnP problem using, for example, a known method (for example, the document: Mikael Persson et al. “Lambda Twist: An Accurate Fast Robust Perspective Three Point (P3P) Solver.”, ECCV 2018, pp 334-349, published in 2018, http://openaccess.thecvf.com/content_ECCV_2018/papers/Mikael_Persson_Lambda_Twist_An_ECCV_2018_paper.pdf) such as Lambda Twist.

When collating the characteristic point extracted from the captured image by the camera 16B with the feature point stored in the map data 18D, the control unit 11 may calculate the current position of the vehicle 1 as a temporary position based on the movement amount of the vehicle 1 described above, for example, and may narrow down the feature point to be collated with the characteristic points extracted from the captured image by the camera 16B among the feature points stored in the map data 18D with the temporary position as a reference.

Through these processes, the control unit 11 estimates current position information including information related to the two-dimensional position (X coordinate, Y coordinate) of the vehicle 1 in the real space and the direction of the vehicle 1 as current position information indicating the current position of the vehicle 1 based on the map data 18D and the captured image around the vehicle 1 acquired by at least one camera 16B.

Then, the control unit 11 causes the vehicle 1 to autonomously travel from the predetermined position P1 toward the parking target position P2 along the teacher route R2 by controlling the movement control unit 12 so that the estimated current position of the vehicle 1 is a position on the teacher route R2 represented by the teacher route data 18E. Then, the control unit 11 stops the vehicle 1 at the parking target position P2.

When the vehicle 1 autonomously travels along the travel route R, the control unit 11 feedback-controls the movement control unit 12 so that the vehicle 1 moves along the teacher route R2 based on the estimated current position of the vehicle 1 and each position on the teacher route R2 represented by the teacher route data 18E.

Here, in a case where the autonomous traveling is performed using the travel route R on which the vehicle has actually traveled at the time of teacher traveling as the teacher route R2, it may be difficult to follow at the time of the autonomous traveling. That is, when the traveling that is difficult to follow at the time of the autonomous traveling is performed at the time of the teacher traveling, the autonomous traveling along the teacher route R2 may be difficult in a case where the travel route R at the time of teacher traveling is used as it is as the teacher route R2.

Therefore, in the present embodiment, the control unit 11 corrects the stored travel route R based on the stored external situation. That is, the control unit 11 corrects at least part of the travel route R that is represented by the travel route data 18B and on which the vehicle actually traveled at the time of teacher traveling based on the external situation represented by the stored external situation data 18C.

The control unit 11 generates a correction route R1 in which at least part of the travel route R is corrected so that the vehicle can travel along the travel route R at the time of autonomous traveling.

In the present embodiment, the control unit 11 corrects the curvature of the curvature partial route having the predetermined curvature or more in the stored travel route R to be less than the predetermined curvature based on the stored external situation.

As the predetermined curvature, a maximum curvature at which the vehicle 1 can travel at the time of autonomous traveling may be set in advance. For example, the curvature of the traveling locus obtained by the autonomous traveling with the maximum steering angle by the restriction of the electric power steering at the time of autonomous traveling may be set in advance as the predetermined curvature.

The control unit 11 identifies a curvature partial route included in the travel route R. Then, the control unit 11 corrects at least part of the travel route R so that the curvature of the identified curvature partial route is equal to or less than a predetermined curvature.

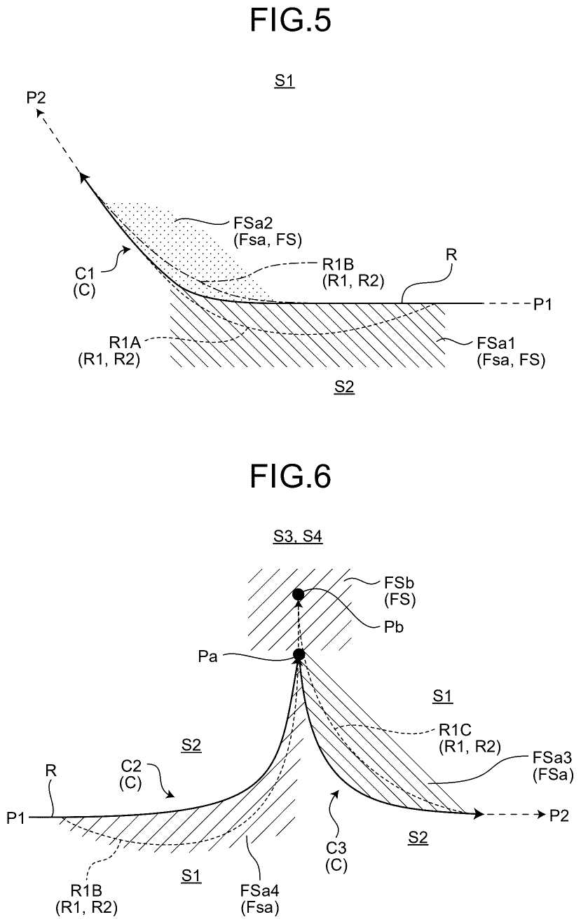

FIG. 5 is an explanatory diagram illustrating an example of generation of the correction route R1 by the control unit 11.

For example, it is assumed that the travel route R includes a curvature partial route C1 having a predetermined curvature or more. The curvature partial route C1 is an example of the curvature partial route C. In this case, the control unit 11 corrects the curvature of the curvature partial route C1 to be less than the predetermined curvature.

Specifically, the control unit 11 identifies the curvature partial route C1 included in the travel route R represented by the travel route data 18B. The control unit 11 may identify, as the curvature partial route C1, an area including a portion route having a curvature equal to or more than a predetermined curvature in the travel route R represented by the travel route data 18B.

Then, the control unit 11 generates the correction route R1 in which at least part of the travel route R is corrected such that the curvature of the identified curvature partial route C1 is less than the predetermined curvature.

The control unit 11 obtains a side free space FSa which vehicle 1 can enter in the first side direction S1 and the second side direction S2 with respect to the vehicle 1 based on the stored external situation.

The side free space FSa is an example of a free space FS.

The free space FS is a space which the vehicle 1 can enter in the real space around the vehicle 1. In addition, the free space FS is a space at least partially non-overlapping with the travel route R.

The free space FS includes a side free space FSa and a front-rear free space. The side free space FSa is a free space FS which the vehicle 1 can enter in the first side direction S1 and the second side direction S2. The front-rear free space is a free space FS which the vehicle 1 can enter in at least one of the front side direction S3 and the rear side direction S4 with respect to the vehicle 1.

The control unit 11 analyzes the external situation data 18C corresponding to the travel information of each position of the vehicle 1 constituting the curvature partial route C1 in the travel route R represented by the travel route data 18B. Through this analysis process, the control unit 11 identifies, as the side free space FSa, a region, around the travel route R, where no obstacle is present, that the vehicle 1 can enter, and which is adjacent (continuous) to the curvature partial route C1 in at least one of the first side direction S1 or the second side direction S2. In addition, by this analysis processing, the control unit 11 identifies, as the front-rear free space, a region, around the travel route R, where no obstacle is present, that the vehicle 1 can enter, and which is adjacent (continuous) to the curvature partial route C1 in at least one of the front side direction S3 and the rear side direction S4 when the vehicle 1 is located on the curvature partial route C1.

FIG. 5 illustrates, as an example, a scene where control unit 11 identifies a side free space FS1 present in the second side direction S2 with respect to travel route R and a side free space FS2 present in the first side direction S1 with respect to travel route R.

Then, the control unit 11 corrects the stored travel route R based on the side free space FSa. Specifically, the control unit 11 corrects at least part of the travel route R to the correction route R1 passing through the side free space FSa such that the curvature of the curvature partial route C1 is less than the predetermined curvature.

When identifying the curvature partial route C1 representing a right turn or a left turn, the control unit 11 preferably corrects the travel route R to the correction route R1 that preferentially passes through the side free space FSa corresponding to space in a direction opposite to the turning direction (right side in FIG. 5) of the vehicle 1 along the route of the curvature represented by the curvature partial route C1. By correcting the travel route to the correction route R1 that preferentially passes through the side free space FSa corresponding to a space in a direction opposite to the turning direction (the right side in FIG. 5) of the vehicle 1, it is possible to generate the correction route R1 so that the vehicle 1 can travel in a posture along the original travel route R earlier after autonomously traveling on the curvature route portion obtained by correcting the curvature partial route C1 in the correction route R1.

For example, it is assumed that the control unit 11 identifies a curvature partial route C1 representing a right turn or a left turn illustrated in FIG. 5. It is also assumed that the control unit 11 identifies the side free space FSa1 present in the second side direction S2, or the side free space FSa1 present in the second side direction S2 and the side free space FSa2 present in the first side direction S1.

In this case, the control unit 11 corrects the travel route R to a correction route R1A having the curvature less than the predetermined curvature passing through the side free space FSa corresponding to the outside of the curvature circle of the curvature represented by the curvature partial route C1. The correction route R1A is an example of the correction route R1. In other words, the control unit 11 corrects at least part of the travel route R to the correction route R1A passing through the side free space FSa corresponding to a space in a direction opposite to the turning direction (right side in FIG. 5) of the vehicle 1 along the route of the curvature represented by the curvature partial route C1.

In addition, for example, it is assumed that the control unit 11 includes a curvature partial route C1 representing a right turn or a left turn illustrated in FIG. 5. It is assumed that the control unit 11 cannot identify the side free space FSa1 but identifies the side free space FSa2 present in the first side direction S1.

In this case, the control unit 11 corrects at least part of the travel route R to a correction route R1B having a curvature less than the predetermined curvature passing through the side free space FSa2 corresponding to the inside of the curvature circle of the curvature represented by the curvature partial route C1. The correction route R1B is an example of the correction route R1. In other words, the control unit 11 corrects the travel route R to the correction route R1B passing through the side free space FSa2 corresponding to a space in a direction corresponding to the turning direction (right side in FIG. 5) of the vehicle 1 along the route of the curvature represented by the curvature partial route C1.

FIG. 6 is an explanatory diagram illustrating an example of generation of the correction route R1 by the control unit 11. FIG. 6 illustrates, as an example, a case where the travel route R includes a point of turn Pa for changing the orientation and direction of the vehicle 1.

A scene where control unit 11 identifies a side free space FSa4, a front-rear free space FSb, and a side free space FSa3 will be described as an example.

The side free space FSa4 is an example of the side free space FSa present in the first side direction S1 with respect to a curvature partial route C2 present between a predetermined position P1 and a point of turn Pa in the travel route R. The front-rear free space FSb is an example of the front-rear free space FSb present in the front side direction S3 or the rear side direction S4 with respect to the curvature partial route C2 and the curvature partial route C3 constituting the point of turn Pa. The side free space FSa3 is an example of the side free space FSa present in the first side direction S1 with respect to the curvature partial route C3 between the point of turn Pa and the parking target position P2. The curvature partial route C2 and the curvature partial route C3 are examples of the curvature partial route C.

The control unit 11 corrects at least part of the travel route R based on the front-rear free space FSb. First, the control unit 11 corrects the point of turn Pa to a point of turn Pb that is a point in the front-rear free space FSb. Then, the control unit 11 corrects the travel route R to a correction route R1 that passes through the front-rear free space FSb and has a curvature less than the predetermined curvature, the correction route R1 having the point of turn Pb in the front-rear free space FSb as a point of turn, instead of the point of turn Pa.

For example, it is assumed that the control unit 11 identifies the curvature partial route C2 and the curvature partial route C2 in the travel route R including the point of turn Pa illustrated in FIG. 6. It is also assumed that the control unit 11 identifies the side free space FSa3, the side free space FSa4, and the front-rear free space FSb in FIG. 6.

In this case, the control unit 11 corrects the point of turn Pa on the travel route R to the point of turn Pb in the front-rear free space FSb. Then, the control unit 11 corrects the curvature partial route C2 extending from the predetermined position P1 to the point of turn Pa to the correction route R1B passing through the side free space FSa4 from the predetermined position P1 to reach the point of turn Pb and having a curvature less than the predetermined curvature. In addition, the control unit 11 corrects the curvature partial route C3 from the point of turn Pa to the parking target position P2 to the correction route R1C passing through the side free space FSa3 from the point of turn Pc to reach the parking target position P2 and having a curvature less than the predetermined curvature. Through these processes, the control unit 11 generates the correction route R1 represented by the correction route R1B and the correction route R1C.

Returning to FIG. 1, the description will be continued.

The control unit 11 displays, on the display 22, the correction route R1 generated by correcting the travel route R by the above correction processing. The display 22 displays the correction route R1. The display 22 may display the correction route R1 together with the travel route R. The display 22 may display the correction route R1 together with the free space FS.

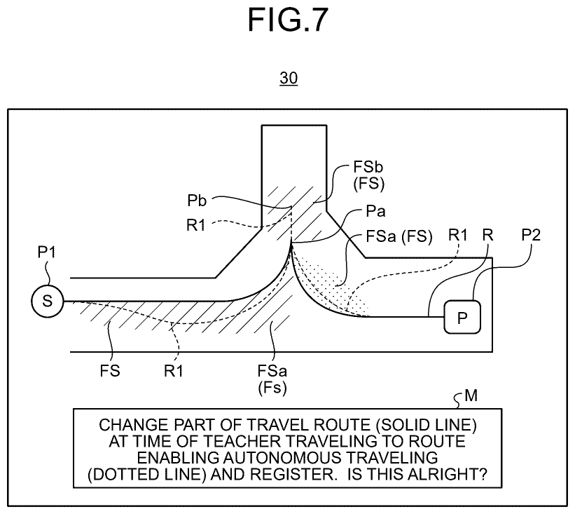

FIG. 7 is a schematic diagram of an example of a display screen 30 displayed by the display 22.

The display screen 30 includes, for example, a predetermined position P1, a parking target position P2, a point of turn Pa, a travel route R from the predetermined position P1 to reach the parking target position P2 via the point of turn Pa, a side free space FSa, a front-rear free space FSb, a point of turn Pb, and a correction route R1. In addition, the display screen 30 may include a message M indicating a message prompting the occupant to approve the registration of a route obtained by changing part of the travel route R at the time of teacher traveling to the correction route R1 as the travel route R.

When the display 22 displays the display screen 30 including at least the correction route R1, the vehicle control device 10 can provide the correction route R1 of the travel route R to the occupant in a recognizable manner.

Returning to FIG. 1, the description will be continued.

The control unit 11 stores the correction route R1 as the teacher route R2 in the storage device 18. That is, the control unit 11 stores the correction route data represented by the correction route R1 obtained by correcting the travel route R in the storage device 18 as the teacher route data 18E representing the teacher route R2. As described above, the control unit 11 may store the teacher route data 18E in the storage device outside the vehicle 1.

When the input device 20 receives a predetermined input after the display 22 displays the correction route R1 obtained by correcting the travel route R, the control unit 11 may store the correction route R1 as the teacher route R2 in the storage device 18.

For example, when the occupant who has visually recognized the display screen 30 illustrated in FIG. 7 displayed on the display 22 accepts to store the displayed correction route R1 as the teacher route R2, the occupant inputs a storage instruction for instructing storage by operating the input device 20. When the input device 20 receives the input of the storage instruction, the control unit 11 may store the correction route data represented by the correction route R1 displayed on the display 22 in the storage device 18 as the teacher route data 18E representing the teacher route R2.

In addition, when the input device 20 receives the instruction of regeneration by the operation by the occupant after the display 22 displays the correction route R1 obtained by correcting the travel route R, the control unit 11 may regenerate the correction route R1 passing through the region in the free space FS different from the correction route R1 generated and displayed last time. Then, when the display 22 displays the correction route R1 and receives the input of the storage instruction by the operation of the input device 20 by the occupant, the control unit 11 may store the correction route data represented by the correction route R1 in the storage device 18 as the teacher route data 18E representing the teacher route R2.

Then, when receiving a signal indicating an instruction to start the autonomous traveling mode by the operation of the input device 20 by the occupant or the like, the control unit 11 switches the traveling mode to the autonomous traveling mode. Then, the control unit 11 estimates the current position of the vehicle 1 based on the map data 18D and the captured image around the vehicle 1 acquired by at least one camera 16B. Then, the control unit 11 causes the vehicle 1 to autonomously travel from the predetermined position P1 toward the parking target position P2 along the teacher route R2 by controlling the movement control unit 12 so that the estimated current position of the vehicle 1 is a position on the teacher route R2 represented by the teacher route data 18E. Then, the control unit 11 stops the vehicle 1 at the parking target position P2.

Therefore, in the vehicle control device 10 of the present embodiment, the correction route R1 obtained by correcting the travel route R on which the vehicle actually travels at the time of teacher traveling based on the external situation is set as the teacher route R2, and the vehicle can autonomously travel along the teacher route R2.

Next, an example of a flow of information processing executed by the control unit 11 of the vehicle control device 10 will be described.

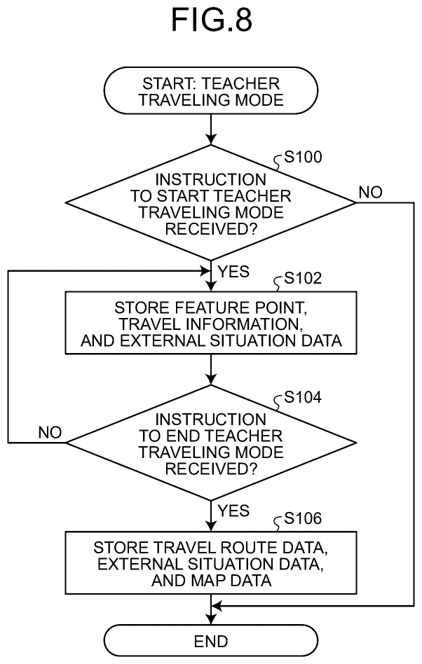

FIG. 8 is a flowchart illustrating an example of a flow of information processing executed by the control unit 11 in the teacher traveling mode.

The control unit 11 determines whether a signal indicating an instruction to start the teacher traveling mode has been received from the input device 20 (step S100). When a negative determination is made in step S100 (step S100: No), this routine is ended. When an affirmative determination is made in step S100 (step S100: Yes), the process proceeds to step S102.

When the teacher traveling of the vehicle 1 is started by the driving operation of the vehicle 1 by the occupant, the control unit 11 sequentially stores the feature point, the travel information, and the external situation data 18C in the storage device 18 (step S102). Specifically, the control unit 11 sequentially stores the current position of the vehicle 1 sequentially estimated along the teacher traveling of the vehicle 1 in the route management DB 18A. At this time, the control unit 11 assigns an INDEX to the current position, and sequentially stores the travel position which is a current position, the azimuth, the traveling direction, and the reference travel information in association with each other as the travel information. In addition, the control unit 11 registers, in the route management DB 18A, the external situation data 18C representing the external situation acquired by the sensor 16 at the time of teacher traveling at each current position in association with the current position. In addition, the control unit 11 identifies feature points by performing image analysis on captured images captured by the camera 16B at the time of teacher traveling, and sequentially registers the feature points in the map data 18D.

The control unit 11 determines whether an instruction to end the teacher traveling mode has been received (step S104). The control unit 11 determines whether a signal indicating the end instruction has been received from the input device 20 by the input device 20 by the occupant, thereby making the determination in step S104. In a case of negative determination in step S104 (step S104: No), the control unit 11 returns the process to step S102. When an affirmative determination is made in step S104 (step S104: Yes), the control unit 11 advances the process to step S106.

In step S106, the control unit 11 stores the travel route data 18B representing the travel route R on which the vehicle traveled at the time of teacher traveling, the external situation data 18C, and the map data 18D in the storage device 18 (step S106). The control unit 11 stores, in the storage device 18, the travel route data 18B representing the travel route R at the time of teacher traveling represented by the group of the sequentially estimated current position and travel information stored in the processing of step S102. In addition, the control unit 11 stores a group of the travel route data 18B sequentially acquired by the processing of step S102 in the storage device 18. In addition, the control unit 11 stores, in the storage device 18, the map data 18D in which the feature points identified by the processing in step S102 are registered. Then, this routine is ended.

Next, an example of a flow of a teacher route storage process executed by the control unit 11 will be described.

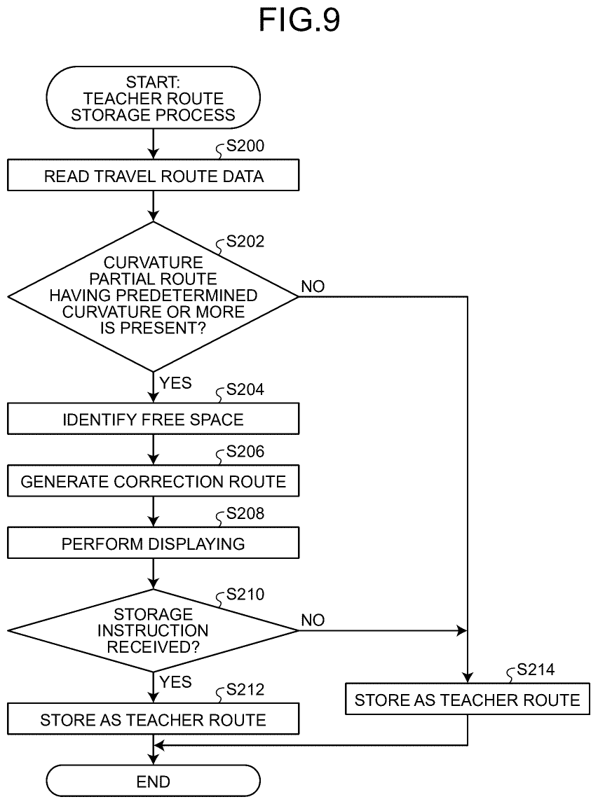

FIG. 9 is a flowchart illustrating an example of a flow of a teacher route storage process executed by the control unit 11. The control unit 11 may execute the teacher route storage process at least at a timing after the travel route data 18B is stored in the storage device 18.

The control unit 11 reads the travel route data 18B from the storage device 18 (step S200). Then, the control unit 11 determines whether a curvature partial route C with a predetermined curvature or more is included in the travel route R represented by the travel route data 18B (step S202). When it is determined that the curvature partial route C is included (step S202: Yes), the process proceeds to step S204.

In step S204, the control unit 11 identifies the free space FS (step S204). The control unit 11 reads the external situation data 18C corresponding to each of the plurality of pieces of travel information constituting the curvature partial route C from the storage device 18. Then, the control unit 11 analyzes the read external situation data 18C. Through this analysis process, the control unit 11 identifies, as the side free space FSa, a region, around the travel route R, where no obstacle is present, that the vehicle 1 can enter, and which is adjacent (continuous) to the curvature partial route C in at least one of the first side direction S1 or the second side direction S2. In addition, by this analysis processing, the control unit 11 identifies, as the front-rear free space FSb, a region, around the travel route R, where no obstacle is present, that the vehicle 1 can enter, and which is adjacent (continuous) to the curvature partial route C in at least one of the front side direction S3 and the rear side direction S4 when the vehicle 1 is located on the curvature partial route C.

Next, based on the free space FS identified in step S204, the control unit 11 generates the correction route R1 obtained by correcting the travel route R represented by the travel route data 18B read in step S202 (step S206). As described above, the control unit 11 corrects at least part of the travel route R to the correction route R1 passing through the free space FS such that the curvature of the curvature partial route C identified in step S202 is less than the predetermined curvature.

The control unit 11 displays, on the display 22, the display screen 30 including the correction route R1 generated in step S206 (step S208). By the processing in step S208, the display 22 displays the display screen 30 illustrated in FIG. 7, for example.

The control unit 11 determines whether the input device 20 has received a storage instruction (step S210). The control unit 11 performs the determination in step S210 by determining whether a storage instruction indicating that the correction route R1 displayed by the operation of the input device 20 by the occupant is stored as the teacher route R2 is input. When an affirmative determination is made in step S210 (step S210: Yes), the control unit 11 advances the process to step S212. When a negative determination is made in step S210 (step S210: No), the process proceeds to step S214 described later.

In step S212, the control unit 11 stores the correction route data represented by the correction route R1 displayed on the display 22 in step S208 in the storage device 18 as the teacher route data 18E representing the teacher route R2 (step S212). Then, this routine is ended.

On the other hand, when a negative determination is made in step S202 (step S202: No), the process proceeds to step S214. In step S214, the control unit 11 stores the travel route data 18B in the storage device 18 as the teacher route data 18E representing the teacher route R2 (step S214). Then, this routine is ended.

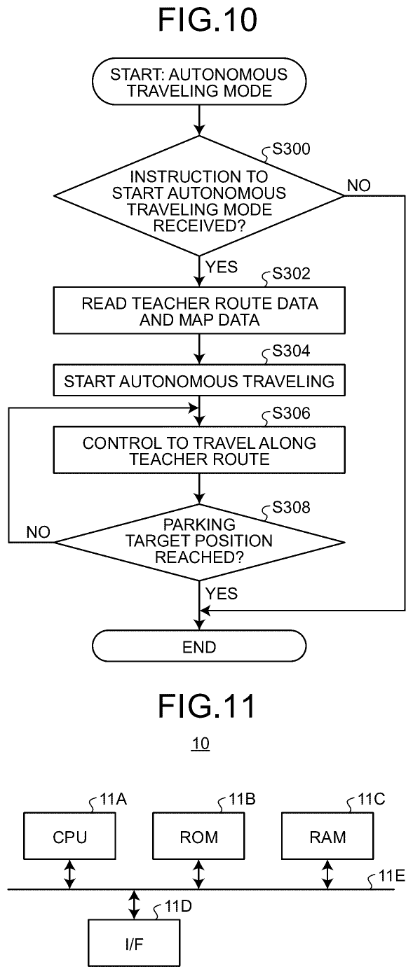

FIG. 10 is a flowchart illustrating an example of a flow of information processing executed by the control unit 11 in the autonomous traveling mode.

The control unit 11 determines whether a signal indicating an instruction to start the autonomous traveling mode has been received (step S300). The control unit 11 determines whether a signal indicating an instruction to start the autonomous traveling mode has been received from the input device 20, thereby making the determination in step S300. When a negative determination is made in step S300 (step S300: No), this routine is ended. When an affirmative determination is made in step S300 (step S300: Yes), the process proceeds to step S302.

In step S302, the control unit 11 reads the teacher route data 18E and the map data 18D from the storage device 18 (step S302). Then, the control unit 11 starts autonomous traveling along the teacher route R2 (step S304).

The control unit 11 controls the movement control unit 12 so as to perform autonomous traveling along the teacher route R2 represented by the teacher route data 18E read in step S302 (step S306). That is, the control unit 11 causes the vehicle 1 to autonomously travel from the predetermined position P1 toward the parking target position P2 along the teacher route R2 by controlling the movement control unit 12 so that the current position of the vehicle 1 included in the travel sensor information acquired from the travel sensor 14 is a position on the teacher route R2 represented by the teacher route data 18E. Then, the control unit 11 determines whether the vehicle 1 has reached the parking target position P2 (step S308). When a negative determination is made in step S308 (step S308: No), the process returns to step S306. When an affirmative determination is made in step S308 (step S308: Yes), this routine is ended.

As described above, the vehicle control device 10 of the present embodiment is set to be connected to the sensor 16 that acquires the external situation, the display 22 with which an occupant is allowed to perform visual recognition, and the movement control unit 12 that controls at least steering. The vehicle control device 10 is a vehicle control device 10 set to be executed by the vehicle 1 capable of autonomously traveling to the parking target position P2 by controlling at least steering along a teacher route R2 obtained by teacher traveling from the predetermined position P1 to the parking target position P2.

The sensor 16 can detect at least an obstacle in each of the first side direction S1 with respect to the vehicle 1 and the second side direction opposite to the first side direction. The vehicle control device 10 stores the travel route R on which the vehicle actually traveled at the time of teacher traveling and the external situation acquired by the sensor 16, and corrects the stored travel route R based on the stored external situation. The display 22 displays the correction route R1 obtained by correcting the travel route R. The vehicle control device 10 is set to store the correction route R1 as the teacher route R2.

As described above, the vehicle control device 10 of the present embodiment corrects the travel route R on which the vehicle has actually traveled in the teacher traveling based on the situation outside the vehicle 1. Then, the vehicle control device 10 stores the correction route R1 obtained by correcting the travel route R as the teacher route R2. Therefore, at the time of autonomous traveling, the vehicle 1 can autonomously travel from the predetermined position P1 to the parking target position P2 along the teacher route R2 using the correction route R1 obtained by correcting the travel route R instead of the travel route R as the teacher route R2.

Therefore, the vehicle control device 10 of the present embodiment can suppress the storage of the travel route R that is difficult to follow at the time of autonomous traveling as the teacher route R2, and can suppress the difficulty in parking assistance by autonomous traveling along the teacher route R2.

Therefore, the vehicle control device 10 of the present embodiment can provide more suitable parking assistance.

Next, a hardware configuration of the vehicle control device 10 of the present embodiment will be described.

FIG. 11 is a block diagram illustrating a hardware configuration example of the vehicle control device 10.

The vehicle control device 10 has a hardware configuration using a normal computer in which a central processing unit (CPU) 11A, a read only memory (ROM) 11B, a random access memory (RAM) 11C, an I/F 11D for connecting to various devices, and the like are connected to each other by a bus 11E.

The CPU 11A is an arithmetic device that controls the entire processing of the vehicle control device 10. The RAM 11C stores data necessary for various processes by the CPU 11A. The ROM 11B stores programs and the like for realizing various processes by the CPU 11A. The I/F 11D is an interface that is connected to an external device or an external terminal via a communication line or the like to transmit and receives data to and from the connected external device or external terminal.

The program for executing the above-described various processes executed by the vehicle control device 10 is provided by being incorporated in the ROM 11B or the like in advance. The program for executing the vehicle control method executed in the present embodiment may be provided by being recorded in a computer-readable recording medium such as a CD-ROM, a flexible disk (FD), a CD-R, or a digital versatile disc (DVD) as a file in a format installable or executable in these devices.

In addition, the program for executing the vehicle control method executed in the present embodiment may be stored on a computer connected to a network such as the Internet and provided by being downloaded via the network. In addition, the program for executing the vehicle control method executed in the present embodiment may be provided or distributed via a network such as the Internet.

According to the vehicle control method according to the present disclosure, more suitable parking assistance can be provided.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A vehicle control method executed in a vehicle that includes a sensor that acquires an external situation, a display visually recognizable by an occupant, and a movement controller that controls at least steering, the vehicle being capable of autonomously traveling to a parking target position along a teacher route obtained by teacher traveling from a predetermined position to the parking target position, by controlling at least steering, wherein
the sensor is capable of detecting an obstacle at least in a first side direction with respect to the vehicle and in a second side direction opposite to the first side direction, and
the vehicle control method comprising:
storing a travel route actually traveled and an external situation acquired through the sensor at a time of the teacher traveling;
correcting the stored travel route based on the stored external situation;
displaying, through the display, a correction route obtained by correcting the travel route; and
storing the correction route as the teacher route.

2. The vehicle control method according to claim 1, comprising
displaying, through the display, the correction route together with the travel route.

3. The vehicle control method according to claim 1, comprising:
obtaining a side free space which the vehicle is allowed to enter in the first side direction and the second side direction with respect to the vehicle, based on the stored external situation; and
correcting the stored travel route based on the side free space.

4. The vehicle control method according to claim 3, comprising
displaying, through the display, the correction route together with the side free space.

5. The vehicle control method according to claim 3, comprising:
correcting the stored travel route to a route passing through the side free space, based on the side free space.

6. The vehicle control method according to claim 1, wherein
the sensor is further capable of detecting an obstacle at least in front of and behind the vehicle, and
the vehicle control method comprising:
obtaining a front-rear free space which the vehicle is allowed to enter in front of and behind the vehicle, based on the stored external situation; and
correcting the stored travel route based on the front-rear free space.

7. The vehicle control method according to claim 6, comprising
displaying, through the display, the correction route together with the front-rear free space.

8. The vehicle control method according to claim 1, wherein
the sensor includes at least one of a camera including an imaging element, a sonar that transmits and receives a sound wave, and a radar or a lidar that transmits and receives an electromagnetic wave.

9. The vehicle control method according to claim 1, wherein
the vehicle further includes an input device that receives an input by the occupant, and
the vehicle control method comprising storing the correction route as the teacher route, when receiving, through the input device, a predetermined input after displaying, through the display, the correction route.

10. The vehicle control method according to claim 1, comprising:
correcting a curvature of a curvature partial route having a predetermined curvature or more in the stored travel route to be less than the predetermined curvature, based on the stored external situation.

11. A vehicle control device that is set to be connected to a sensor that acquires an external situation, a display visually recognizable by an occupant, and a movement controller that controls at least steering, and is set to be implemented in a vehicle capable of autonomously traveling to a parking target position along a teacher route obtained by teacher traveling from a predetermined position to the parking target position, by controlling at least steering, wherein
the sensor is capable of detecting an obstacle at least in a first side direction with respect to the vehicle and a second side direction opposite to the first side direction, and
the vehicle control device is set to:
store a travel route actually traveled and an external situation acquired through the sensor at a time of the teacher traveling;
correct the stored travel route based on the stored external situation;
display, through the display, a correction route obtained by correcting the travel route; and
store the correction route as the teacher route.

12. The vehicle control device according to claim 11, wherein
the vehicle control device is set to display, through the display, the correction route together with the travel route.

13. The vehicle control device according to claim 11, wherein
the vehicle control device is set to:
obtain a side free space which the vehicle is allowed to enter in the first side direction and the second side direction with respect to the vehicle, based on the stored external situation; and
correct the stored travel route based on the side free space.

14. The vehicle control device according to claim 13, wherein
the vehicle control device is set to display, through the display, the correction route together with the side free space.

15. The vehicle control device according to claim 13, wherein
the vehicle control device is set to correct the stored travel route to a route passing through the side free space, based on the side free space.

16. The vehicle control device according to claim 11, wherein
the sensor is further capable of detecting an obstacle at least in front of and behind the vehicle, and
the vehicle control device is set to:
obtain a front-rear free space which the vehicle is allowed to enter in front of and behind the vehicle, based on the stored external situation; and
correct the stored travel route based on the front-rear free space.

17. The vehicle control device according to claim 16, wherein
the vehicle control device is set to display, through the display, the correction route together with the front-rear free space.

18. The vehicle control device according to claim 11, wherein
the sensor includes at least one of a camera including an imaging element, a sonar that transmits and receives a sound wave, and a radar or a lidar that transmits and receives an electromagnetic wave.

19. The vehicle control device according to claim 11, wherein
the vehicle further includes an input device that receives an input by the occupant, and
the vehicle control device is set to store the correction route as the teacher route, when receiving, through the input device, a predetermined input after displaying, through the display, the correction route.

20. The vehicle control device according to claim 11, wherein
the vehicle control device is set to correct a curvature of a curvature partial route having a predetermined curvature or more in the stored travel route to be less than the predetermined curvature, based on the stored external situation.
